(19) United States
(12) Patent Application Publication
(10) Pub. No.: US 2006/0029772 A1
(43) Pub. Date: Feb. 9, 2006

(54) Elastic composite material having massaging and breathing characteristics

(75) Inventors: Ting-Sheng Huang, Yung-Kang City (TW); Ching-Hui Lee, Yung-Kang City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Nam Liong Enterprise Co., Ltd.

(21) Appl. No.: 10/910,826

(22) Filed: Aug. 3, 2004

(51) Int. Cl. B32B 3/10

(52) U.S. Cl. 428/138

(57) ABSTRACT

An elastic composite material having breathing characteristics and a massaging effect includes a substrate made from a closed cell rubber foam and formed with through-holes and protrusions, and a fabric sheet bonded to the substrate. Each of the through-holes has first and second ends and a varied cross-section that diverges from the first end to the second end. The ratio of the cross-section area of the second end of each of the through-holes to the cross-section area of the first end of each of the through-holes ranges from 1.2 to 5.0. The ratio of the total cross-section area of the second ends of the through-holes to the surface area of a surface of the substrate is less than 30%. Each of the protrusions has a height ranging from 0.5 mm to 6 mm relative to the surface of the substrate.

### BACKGROUND OF THE INVENTION

1. Field of the Invention

This invention relates to an elastic composite material having massaging and breathing characteristics, more particularly to an elastic composite material having soft and thermal insulating characteristics and formed with a plurality of protrusions and a plurality of through-holes, each of which has a varied cross-section, so as to have massaging and breathing characteristics.

2. Description of the Related Art

Conventional rubber-based padding materials are useful for manufacturing shoes, protective pads, elastic cloths, and elastic pads. In the protective pads for medicare use or for sports use, holes may be formed therein for transmission of water vapor or sweat. If the holes are small, ventilation or circulation of water vapor or sweat covered by the protective pads is relatively poor. Although larger holes can provide better ventilation of water vapor, they also degrade in thermal insulation property of the protective pad. In addition, articles are difficult to be attached to the conventional protective pads, and delamination of the assembly tends to occur.

### SUMMARY OF THE INVENTION

The object of the present invention is to provide an elastic composite material that is capable of overcoming the aforesaid drawbacks associated with the prior art.

According to this invention, an elastic composite material having breathing and massaging characteristics comprises: an elastic substrate having opposite first and second surfaces, and formed with a plurality of spaced apart through-holes that extend transversely through the first and second surfaces, and a plurality of spaced apart protrusions that project outwardly and transversely from the second surface, each of the through-holes having a first end disposed at the first surface, a second end opposite to the first end and disposed at the second surface, and a varied cross-section that diverges from the first end to the second end, each of the first and second ends of each of the through-holes having a cross-section area, the second surface of the substrate having a surface area, the second ends of the through-holes and the protrusions being arranged in a staggered manner; a first adhesive; and a first fabric sheet bonded to the first surface of the substrate through the first adhesive. The elastic substrate has a tensile strength greater than 4 Kg/cm², and an elongation rate ranging from 50% to 500%. The ratio of the cross-section area of the second end of each of the through-holes to the cross-section area of the first end of each of the through-holes ranges from 1.2 to 5.0. The ratio of the total cross-section area of the second ends of the through-holes to the surface area of the second surface of the substrate is less than 30%. Each of the protrusions has a height ranging from 0.5 mm to 6 mm relative to the second surface of the substrate, and a cross-section less than 25 mm². The first adhesive has a nonvolatile content ranging from 25 wt %-50 wt %. The first fabric sheet has a water repellent rating less than 80 measured in accordance with AATCC test method 22.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic top view of the first preferred embodiment of an elastic composite material according to this invention;

FIG. 2 is a schematic sectional view of the first preferred embodiment; and

FIG. 3 is a schematic sectional view of the second preferred embodiment of the elastic composite material according to this invention.

### DETAILED DESCRIPTION OF THE PREFERRED EMBODIMENTS

Before the present invention is described in greater detail, it should be noted that same reference numerals have been used to denote like elements throughout the specification.

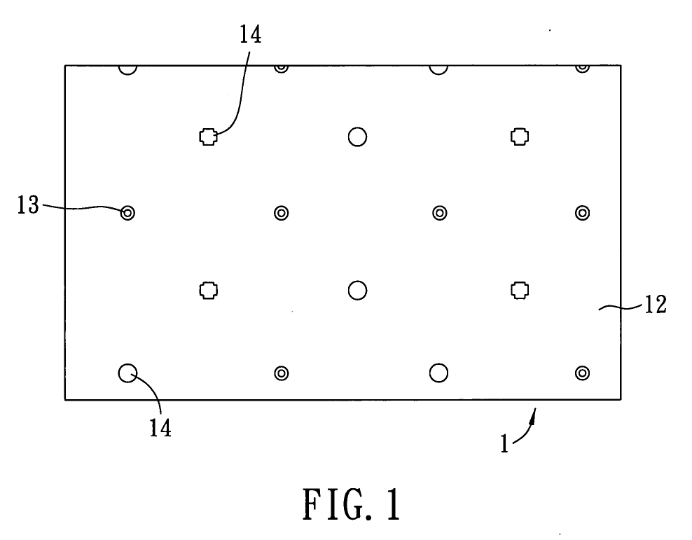

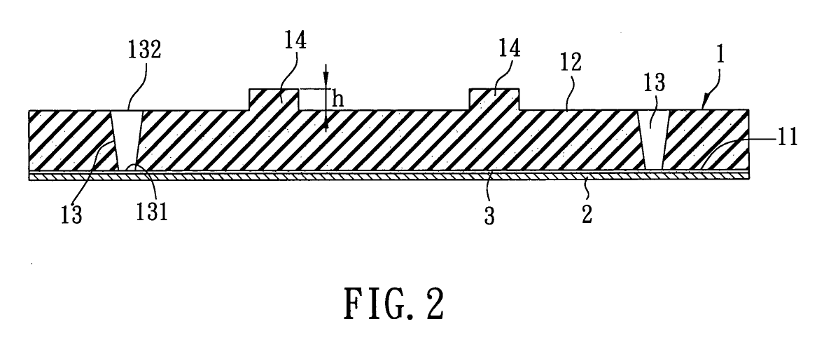

FIGS. 1 and 2 illustrate the first preferred embodiment of an elastic composite material that has massaging and breathing characteristics according to the present invention.

The elastic composite material includes an elastic substrate 1 made from a closed cell rubber foam, having opposite first and second surfaces 11, 12, and formed with a plurality of spaced apart through-holes 13 that extend transversely through the first and second surfaces 11, 12, and a plurality of spaced apart protrusions 14 that project outwardly and transversely from the second surface 12 of the substrate 1. Each of the through-holes 13 has a first end 131 disposed at the first surface 11, a second end 132 opposite to the first end 131 and disposed at the second surface 12, and a varied cross-section that diverges from the first end 131 to the second end 132 of the through-hole 13. A first fabric sheet 2 is bonded to the first surface 11 of the substrate 1 through a first adhesive 3. The second ends 132 of the through-holes 13 and the protrusions 14 are arranged in a staggered manner.

Preferably, the closed cell rubber foam of the substrate 1 is made from a material selected from the group consisting of chloroprene (CR), styrene-butadiene rubber (SBR), natural rubber (NR), ethylene propylene rubber (EPDM), and ethylene vinyl acetate (EVA), and has a tensile strength greater than 4 Kg/cm² measured in accordance with ASTM D412, and an elongation rate ranging from 50% to 500% measured in accordance with ASTM D412. When the elongation rate of the substrate 1 is less than 50%, i.e., the elasticity of the substrate 1 is poor, wearing or removal of the elastic composite material from the user's body becomes difficult, and wearing of the elastic composite material tends to result in considerable discomfort. When the elongation rate of the substrate 1 is greater than 500%, the elastic composite material tends to undesirably slip off from the user during the use thereof, and micro breakage tends to occur in the structure of the substrate 1. The tensile strength and the elongation rate of the substrate 1 can be different for various applications.

The cross-section of each of the through-holes 13 can be circular, oval, triangular, or trapezoid in shape, and is preferably circular in shape. The cross-section of the second end 132 of each of the through-holes 13 preferably ranges from 1 to 7 mm², and the ratio of the cross-section area of the second end 132 of each of the through-holes 13 to the cross-section area of the first end 131 of each of the through-holes 13 preferably ranges from 1.2 to 5.0 so as to permit a high transmission of water vapor and to provide a good thermal insulation property. When the aforesaid ratio is less than 1.2, the transmission of water vapor is poor for the substrate 1, whereas when the ratio is greater than 5.0, the through-holes 13 in the substrate 1 tend to be easily deformed by compression of the skin of the user, which, in turn, results in a decrease in the transmission of water vapor.

Each of the through-holes 13 is preferably spaced apart from an adjacent one of the through-holes 13 by a distance greater than 2 mm and preferably ranging from 6 mm to 18 mm, and the ratio of the total cross-section area of the second ends 132 of the through-holes 13 to the surface area of the second surface 12 of the substrate 1 is preferably less than 30%, otherwise the substrate 1 will tend to be easily deformed and even break when stretched.

The protrusions 14 can be circular or crossed in shape, and preferably have a hardness that is sufficient to space apart the elastic composite material from the skin of the user so as to permit ventilation of water vapor therebetween and so as to provide a massage function, and that is preferably less than 30 degrees measured in accordance with ASKER C-type measuring method so as to provide a sufficient softness to the user. Each of the protrusions 14 has a height (h) ranging from 0.5 mm to 6 mm relative to the second surface 12 of the substrate 1. When the height (h) of each of the protrusions 14 is less than 0.5 mm, the spacing between the elastic composite material and the skin of the user is too small, and ventilation of water vapor is poor, whereas when the height (h) of each of the protrusions 14 is greater than 6 mm, discomfort tends to occur for the user. The ratio of the total cross-section area of the protrusions 14 to the second surface 12 of the substrate 1 preferably ranges from 10% to 80%. Each of the protrusions 14 preferably has a cross-section area less than 25 mm², and is preferably spaced apart from an adjacent one of the protrusions 14 by a distance ranging from 1 mm to 50 mm. Note that the cross-section area of each of the protrusions 14 is herein defined as the maximum cross-section of the protrusion 14.

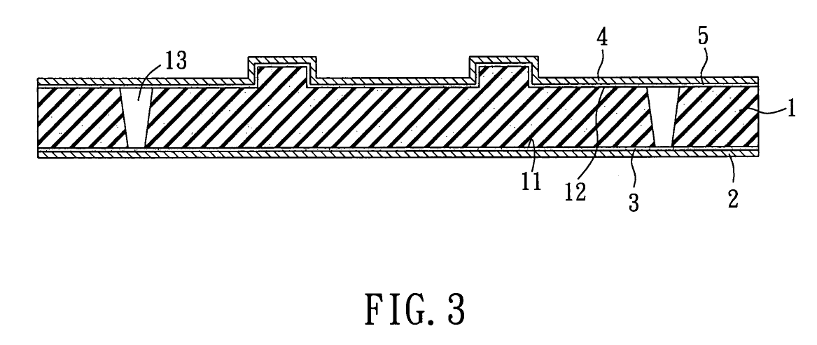

FIG. 3 illustrates the second preferred embodiment of the elastic composite material according to this invention. The elastic composite material of this embodiment differs from the previous embodiment in that a second fabric sheet 4 is bonded to the second surface 12 of the substrate 1 through a second adhesive 5.

Each of the first and second fabric sheets 2, 4 is preferably made from a material selected from the group consisting of Nylon and polyester, and preferably has an elongation rate ranging from 50% to 500% in a warp direction and from 50% to 500% in a weft direction.

Preferably, each of the first and second fabric sheets 2, 4 has a water repellent (spray test) rating less than 80 measured in accordance with AATCC (American Associated of Textile Chemists and Colorists) test method 22. When the water repellent rating is greater than 80, the transmission of water vapor through the elastic composite material is significantly and adversely affected.

Each of the first and second adhesives 3, 5 contains a nonvolatile material that is preferably made from the group consisting of a chloroprene adhesive and a polyurethane adhesive, and preferably has a nonvolatile content ranging from 25 wt % to 50 wt %. When the nonvolatile content is greater than 50 wt %, the through-holes 13 in the substrate 1 tend to be blocked by the first and second adhesives 3, 5, whereas when the nonvolatile content is less than 25 wt %, the bonding strength between the substrate 1 and the first and second fabric sheets 2, 4 is relatively weak.

The elastic composite material of this invention is prepared by forming the closed cell rubber foam of the substrate 1, applying the first and second adhesives 3, 5 to the first and second surfaces 11, 12 of the substrate 1, drying the first and second adhesives 3, 5, and subsequently forming the protrusions 14.

### EXAMPLES

The present invention will be described in more detail in the following Examples.

### Example 1

The elastic composite material of this Example, which corresponds to the first preferred embodiment, was prepared by the following steps. The elastic substrate 1 was formed by blending a mixture of SBR and NR, followed by two-staged foaming operation using a mold to form a foam body. The foam body was cut so as to form the substrate 1 that has a thickness of 4 mm. The elongation rate and the tensile strength of the substrate 1 are shown in Table 1. The thus formed substrate 1 was formed into a plurality of the through-holes 13 using a mold formed with conical protrusions. The second end 132 of each of the through-holes 13 has a cross-section area of 3.47 mm². The total cross-section area of the second ends 132 of the through-holes 13 to that of the first ends 131 of the through-holes 13 is 2.82. The second end 132 of each of the through-holes 13 is spaced apart from the second end 132 of an adjacent one of the through-holes 13 by a distance of 6 mm. The ratio of the total cross-section area of the second ends 132 of the through-holes 13 to the second surface 12 of the substrate 1 is 0.291. The substrate 1 was then coated with the first adhesive 3 which contains 27 wt % of a nonvolatile material of polyurethane adhesive, which is measured by ASTM D1582. The first fabric sheet 2 was subsequently attached to the first adhesive 3, and was subjected to roller drying and cooling. The first fabric sheet 2 was woven in warp and weft directions, was made from polyester and cotton, and had an elongation rate shown in Table 1, which were measured by ASTM D5035, and a water repellent rating of 60 measured in accordance with AATCC test method 22. The substrate 1 with the first fabric sheet 2 attached thereto was formed into a plurality of the protrusions 14 through hot pressing using a mold formed with protrusions thereon. Each of the protrusions 14 has a height of 0.5 mm and a cross-section of 19.63 mm². Each two adjacent ones of the protrusions 14 are spaced apart from each other by a distance of 6 mm. The ratio of the total cross-section area of the protrusions 14 to the surface area of the second surface 132 of the substrate 1 is 0.294.

TABLE 1

| Example 1 | | | Test method |
|---|---|---|---|
| Substrate | Elongation rate | 316% | ASTM D412 |
| | Tensile strength | 5.4 Kg/cm² | ASTM D412 |
| First | Nonvolatile content | 27 wt % | ASTM D1582 |
| adhesive | | | |
| First | Elongation rate in warp | 93% | ASTM D5035 |
| fabric | direction | | |
| sheet | Elongation rate in weft | 367% | ASTM D5035 |
| | direction | | |
| | Water repellent rating | 60 | AATCC 22 |

### Example 2

The elastic composite material of this Example, which corresponds to the second preferred embodiment, was prepared by the following steps. The elastic substrate 1 was formed by blending a mixture of SBR and CR, followed by two-staged foaming operation using a mold to form a foam body. The foam body was cut so as to form the substrate 1 that has a thickness of 4 mm. The elongation rate and the tensile strength of the substrate 1 are shown in Table 2. The thus formed substrate 1 was formed into a plurality of the through-holes 13 using a mold formed with conical protrusions. The second end 132 of each of the through-holes 13 has a cross-section area of 1.77 mm². The total cross-section area of the second ends 132 of the through-holes 13 to that of the first ends 131 of the through-holes 13 is 1.44. The second end 132 of each of the through-holes 13 is spaced apart from the second end 132 of an adjacent one of the through-holes 13 by a distance of 4 mm. The ratio of the total cross-section area of the second ends 132 of the through-holes 13 to the second surface 12 of the substrate 1 is 0.062. The first surface 11 of the substrate 1 was then coated with the first adhesive 3 which contains 30 wt % of a nonvolatile material of chloroprene adhesive, which is measured by ASTM D1582. The first fabric sheet 2 was subsequently attached to the first adhesive 3, and was subjected to roller drying and cooling. The first fabric sheet 2 was woven in warp and weft directions, was made from Nylon (polyamide) and polyurethane (85% polyurethane long chain polymer fibers), and had an elongation rate shown in Table 2, which were measured by ASTM D5035, and a water repellent rating of 60 measured in accordance with AATCC test method 22. The second surface 12 of the substrate 1 was subsequently coated with the second adhesive 5, which also contains 30 wt % of a nonvolatile material of chloroprene adhesive, for attachment of the second fabric sheet 4 thereto. The second fabric sheet 4 is made from Nylon, and has a water repellent rating shown in Table 2. The assembly of the substrate 1 and the first and second fabric sheets 2, 4 was further subjected to a secondary roller drying and cooling, and was formed into a plurality of the protrusions 14 on the second surface 12 of the substrate 1 through hot pressing using a mold formed with protrusions thereon. Each of the protrusions 14 has a height of 0.5 mm and a cross-section of 18.49 mm² Each two adjacent ones of the protrusions 14 are spaced apart from each other by a distance of 2 mm. The ratio of the total cross-section area of the protrusions 14 to the surface area of the second surface 132 of the substrate 1 is 0.4853.

TABLE 2

| Example 2 | | | Test method |
|---|---|---|---|
| Substrate | Elongation rate | 423% | ASTM D412 |
| | Tensile strength | 6.7 Kg/cm² | ASTM D412 |
| First | Nonvolatile content | 30 wt % | ASTM D1582 |
| adhesive | | | |
| First | Elongation rate in warp | 189% | ASTM D5035 |
| fabric | direction | | |
| sheet | Elongation rate in weft | 421% | ASTM D5035 |
| | direction | | |
| | Water repellent rating | 60 | AATCC 22 |
| Second | Elongation rate in warp | 210% | ASTM D5035 |
| fabric | direction | | |
| sheet | Elongation rate in weft | 416% | ASTM D5035 |
| | direction | | |
| | Water repellent rating | 50 | AATCC 22 |

By varying the cross-section of each of the through-holes 13 in the substrate 1, and with the inclusion of the protrusions 14 in the elastic composite material of this invention, the aforesaid drawbacks associated with the prior art can be obviated. In addition, the protrusions 14 can provide a massage function.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. An elastic composite material having a breathing and massaging characteristics, comprising:
an elastic substrate having opposite first and second surfaces, and formed with a plurality of spaced apart through-holes that extend transversely through said first and second surfaces, and a plurality of spaced apart protrusions that project outwardly and transversely from said second surface, each of said through-holes having a first end disposed at said first surface, a second end opposite to said first end and disposed at said second surface, and a varied cross-section that diverges from said first end to said second end, each of said first and second ends of each of said through-holes having a cross-section area, said second surface of said substrate having a surface area, said second ends of said through-holes and said protrusions being arranged in a staggered manner;
a first adhesive; and
a first fabric sheet bonded to said first surface of said substrate through said first adhesive;
wherein said elastic substrate has a tensile strength greater than 4 Kg/cm², and an elongation rate ranging from 50% to 500%;
wherein the ratio of said cross-section area of said second end of each of said through-holes to said cross-section area of said first end of each of said through-holes ranges from 1.2 to 5.0;
wherein the ratio of the total cross-section area of said second ends of said through-holes to said surface area of said second surface of said substrate is less than 30%;
wherein each of said protrusions has a height ranging from 0.5 mm to 6 mm relative to said second surface of said substrate, and a cross-section less than 25 mm²;
wherein said first adhesive has a nonvolatile content ranging from 25 wt %-50 wt %; and
wherein said first fabric sheet has a water repellent rating less than 80 measured in accordance with AATCC test method 22.

2. The elastic composite material of claim 1, wherein the ratio of the total cross-section area of said protrusions to said second surface of said substrate ranges from 10% to 80%.

3. The elastic composite material of claim 1, wherein said second end of each of said through-holes is spaced apart from said second end of an adjacent one of said through-holes by a distance greater than 2 mm.

4. The elastic composite material of claim 1, wherein each of said protrusions is spaced apart from an adjacent one of said protrusions by a distance ranging from 1 mm to 50 mm.

5. The elastic composite material of claim 1, wherein said substrate is made from a material selected from the group consisting of chloroprene rubber (CR), styrene-butadiene rubber (SBR), natural rubber (NR), ethylene propylene rubber (EPDM), and ethylene vinyl acetate (EVA).

6. The elastic composite material of claim 1, further comprising a second adhesive, and a second fabric sheet bonded to said second surface of said substrate through said second adhesive.

7. The elastic composite material of claim 6, wherein each of said first and second adhesives contain a nonvolatile material that is made from the group consisting of chloroprene adhesive and polyurethane adhesive.

8. The elastic composite material of claim 6, wherein each of said first and second fabric sheets is made from a material selected from the group consisting of Nylon and polyester.

9. The elastic composite material of claim 6, wherein each of said first and second fabric sheets has an elongation rate ranging from 50% to 500% in a warp direction and from 50% to 500% in a weft direction.

10. The elastic composite material of claim 6, wherein said second fabric sheet has a water repellent rating less than 80 measured in accordance with AATCC test method 22.

11. The elastic composite material of claim 6, wherein said second adhesive has a nonvolatile content ranging from 25 wt %-50 wt %.

12. The elastic composite material of claim 1, wherein said cross-section of each of said protrusions is circular in shape.

13. The elastic composite material of claim 1, wherein said cross-section of each of said protrusions is cross in shape.
